(19) United States
(12) Patent Application Publication
(10) Pub. No.: US 2018/0257357 A1
(43) Pub. Date: Sep. 13, 2018

(54) MEMBRANELESS LAMINATOR GROUP AND RELATIVE METHOD FOR MAKING LAMINATED PANELS OF DIFFERENT SIZES, IN PARTICULAR PHOTOVOLTAIC PANELS

(71) Applicant: TEKNISOLAR LTD, Birchwood, Warrington (GB)

(72) Inventors: Vittore DE LEONIBUS, Vasto (IT); Mariano FABIANI, Vasto (IT)

(73) Assignee: TEKNISOLAR LTD, Birchwood, Warrington (GB)

(21) Appl. No.: 15/779,820

(22) PCT Filed: Dec. 9, 2016
(86) PCT No.: PCT/IB2016/057491

§ 371 Date: May 29, 2018

(30) Foreign Application Priority Data
Dec. 11, 2015 (IT) 102015000082473

(51) Int. Cl. B32B 37/00; B30B 15/06; B32B 37/06; B32B 37/10; B32B 37/18

(52) U.S. Cl. CPC B32B 37/003; B30B 15/061; B32B 37/0046; B32B 2309/68; B32B 37/10; B32B 37/18; B32B 2457/12; B32B 37/06

(57) ABSTRACT

Membraneless laminator group (10) for making laminated panels comprising: one sealed lamination chamber (11) comprising a heated support and abutment base (12) for at least one panel; a movable cover (13) for opening and closing the chamber (11); a heated rigid plane (15) movable inside the chamber between a raised position spaced from the panel and a lowered position it presses the panel; wherein the surface of the plane (15) facing the panel is equipped with a thermal cover arranged loosely between the plane and the panel. When the plane (15) is in the raised position, the thermal cover engages the panel so as to transfer heat without acting by compression. When the plane is in the lowered position the thermal cover is in compressed configuration so that the compression is transferred against the panel and possible local thickness variations of the panel are compensated.

The present invention refers to a laminator group and to the relative method for making laminated panels, in particular photovoltaic panels.

In particular, the present invention refers to a laminator group without the typical membrane, conventionally made of silicone.

As known, the term laminated panel is meant to indicate a “sandwich” structure where a plurality of layers are arranged on top of one another.

As an example, a classic crystalline photovoltaic panel can be made up of the following succession of layers starting from the outer face exposed to the sun to the inner or rear one:
a sheet of glass;
a sheet of ethylene vinyl acetate or EVA or other suitable materials for this production technology like for example TPO, PVB, Ionomer, POE.
a layer of mono or polycrystalline cells electrically connected to one another;
a sheet of EVA to protect the cells;
a plastic backsheet or sheet of glass.

A classic thin-film panel can be made up of the following succession of layers starting from the outer face exposed to the sun to the inner or rear one:
a sheet of glass;
a transparent and conductive thin-film coating on the inner face of the outer glass;
a succession of thin layers suitably arranged and formed to operate as solar cells;
a reflective and conductive thin-film coating;
a sheet of EVA or other encapsulant;
a rear covering glass sheet.

Usually, the glass is used as a base on which a thin sheet of EVA is laid. On top of the EVA the cells are positioned with the photosensitive side facing down, and another sheet of EVA and then a sheet of insulating plastic backsheet, made of PET or similar, or another sheet of glass, are laid.

The sandwich made in this way is sent to the laminator. This is a machine in which there is a chamber, kept within a range of temperatures comprised between 140° C. and 180° C. as a function of the rheological characteristics of the plastic interlayer, in which, after having created the vacuum in a few minutes, the polymerization of the EVA or of another plastic interlayer is obtained. A strong pressure is exerted on the panel thus treated to compact the layers. The compacted product then completes the polymerization cycle in a hot environment with temperatures comprised in the range 140-180° C. in the presence of vacuum and continuing to exert pressure.

According to such technology the laminate is capable of withstanding the weather for at least 25/30 years.

Therefore, according to the above, the technological cycle can be summarized in the following steps:

a) de-aeration;
b) compression; and
c) polymerization.

During the de-aeration step, the air trapped between the layers of the panel is eliminated by making a vacuum (about 1 mbar) in the lamination chamber.

Usually, the panel is heated by conduction on the lower face.

In detail, the de-aeration is carried out keeping the panel at a relatively low temperature to avoid early melting and consequent early sealing of the edges by the layers of EVA.

The de-aeration is indeed necessary to avoid the formation of bubbles due to the air naturally present in the panel and to the peroxide generated by the curing of the EVA.

From such a prior art, the purpose of the present invention is to make a laminator group that is an alternative to those known and at the same time particularly efficient.

The second step of compression and polymerization of the plastic film contained in the panel takes place in the lamination chamber. The start of the polymerization usually takes place at a temperature of 80°-90° C. Under these temperature conditions a pressure is applied on the upper face of the panel thus making the adhesion of the layers of EVA to the contiguous layers begin.

In order to increase the production cycle it is possible to provide two or more post-polymerization chambers arranged in parallel in a vertical system or in series, simplifying the group.

Starting from the steps outlined above, the classic laminator group comprises:
a vacuum pumping group connected to the lamination chamber;
the lamination chamber, which can be multi-plane or sized to work simultaneously with plurality of panels;
the support structure with a control unit.

According to the currently most common prior art, the lamination chamber makes a sealed chamber divided into two sub-chambers by a silicone membrane.

When the panel is inserted in the lamination chamber, it rests on the bottom of the chamber and above it, spaced apart, is the silicone membrane.

In this condition, the vacuum pumping group takes care of evacuating the air in both of the chambers making a vacuum of about 1 mbar in the lamination chamber and a slightly greater vacuum in the membrane chamber.

Once the de-aeration has been carried out in the upper sub-chamber, where the panel is not present, air is introduced at atmospheric pressure.

By pressure difference the silicone membrane presses against the panel and carries out the compression step described earlier.

The following table shows the work cycles with indication of the operating temperatures and times.

| | | |
|---|---|---|
| Step | Time | Panel temperature |

| | | | | |
|---|---|---|---|---|
| De-aeration | 150-180 | s | 50°-60° | C. |
| Pressure change | 30-60 | s | 60°-90° | C. |
| Pre-polymerization | 60-120 | s | 90°-120° | C. |
| First post-polymerization | 180-360 | s | 125°-145° | C. |
| Second post-polymerization | 180-360 | s | 125°-145° | C. |

Of course, the values given above are only indicative and depend on the type of panel to be laminated and the materials used.

Finally, in order to heat the chambers currently candle-type electrical resistances are usually used introduced in deep holes formed in the metallic plate on which the panel rests.

Alternatively, it is currently also known to use diathermal oil circulating in the group as heating means.

As stated earlier, the vast majority of known lamination groups uses a silicone membrane as compression element that acts in compression on the panel by virtue of a pressure jump between the upper areas and the lower areas of the membrane itself.

The alternative, practically not used, provides for a rigid plane. Such a rigid plane is not used due to a series of problems, such as to difficulty in reaching high compressive capacities, which the membrane pneumatic system reaches easily, and the poor ability to adapt to different thicknesses and/or to the presence of projections on the surface of the panels.

For example, in photovoltaic panels some of such projections are due to the conductive metal connection bands inside the panel and useful for forming the electrical circuit thereof.

The rigid plane, indeed, in the immediate vicinity of the projection or overpressure (10-50 hundredths of a millimeter) does not exert any pressure creating defects on the panel that can cause it to be discarded. Or it may be the case that the rigid plane presses too much on a portion of panel with the risk of breaking the upper layer of glass.

Starting from such a technical preconception for which reason the persons skilled in the art would currently a priori choose to discard the choice of the rigid plane instead of the silicone membrane, the Applicant has proposed, in the present application, precisely such a replacement starting from the problems due to the membrane and, in general, to the laminators currently known.

The membrane, indeed, introduces two types of drawbacks, one linked to the maintenance of the group and the other linked to the quality of the panel obtained.

As can be imagined, the membrane is per se an element that is easily subjected to cracking or breaking and when this occurs it is not possible to reach the vacuum and compression standard required in the lamination chamber.

Unfortunately, such breaking is perceived by operators only at the outlet of the panels and even by immediately stopping the group it could be the case that at least one other series of panels is unfortunately discarded because it is already inserted in the “damaged” chamber.

In order to avoid such drawbacks, currently the membrane is periodically replaced with long machine down times due to the long manual operations of positioning and hot tensioning of the membrane.

As stated above, however, the membrane also leads to other drawbacks that affect the quality of the panel. The membrane, indeed, by acting pneumatically, spontaneously biases the entire surface in the same way.

By doing so, at the edges, where the plastic interlayer is most “biased” to come out having less perimeter resistance, there is almost always part of the substrate that overlaps with problems of damage on the mat.

Furthermore, such a phenomenon feeds itself because, where the substrate has partially come out, there is further “outlet” for the membrane that thus presses more pushing other substrate outwards.

The membrane pushes so much that, when the substrate comes out from the perimeter edges of the panels, it can even cause the fracture of the glass or the lateral movement thereof. Indeed, although the load is perpendicular, the internal reaction discharges transversally with respect to the direction of compression of the layers.

A further, not secondary, problem of membrane groups is caused by the material coming out which, remaining stuck to the mats, makes its removal problematic.

A further problem of membrane groups is that the heating can only be carried out from below the lamination chamber.

Thus, unfortunately the panel, entering into the chamber for the first de-aeration step, is immediately in contact with a very hot surface of 150°−160° C., with the problem that the EVA already starts to melt quickly preventing correct de-aeration.

The most sophisticated laminators thus have a lifting system from below that spaces the panel being made with respect to the heated plane.

However, even in such cases there is a curvature phenomenon, called butterfly effect, on the panels due to the differential heating and the uneven distribution of the heat on the two outer faces of the panel.

WO 2014/096924 describes a rigid plane laminator group where the pressing step provides for the division of the lamination chamber into a plurality of independent sub-chambers separated by inflatable dividers.

Extremely briefly, the purpose of the present invention is to make a laminator group of the membrane-less type, thus having a rigid plane, capable of overcoming the technical preconception that, as well as the membrane itself, sees as quality factors of the panel a very strong compression lasting a long time and post-polymerization chambers capable of continuing to exert a pressure on the panel and possibly under vacuum.

Moreover, a purpose of the present invention is to make a laminator group having a rigid plane that is capable of treating different shapes of panels, both in terms of size, and due to the different distribution of local elements of non-planarity.

Furthermore, a purpose of the present invention is to make a laminator group having a rigid plane in which the step of heating the panel takes place quickly and optimally.

The invention thus relates to a lamination group and method in which the following principles have been prioritized:
simplicity of the machine to reduce the risks of failure thereof and the maintenance times;
speed of the process to increase the productivity thereof;
quality of the panels produced due to the absence of defects typical of the majority of membrane laminators on the market;
ability to treat different types of panel without requiring setting when passing from one type of panel to another.

The group is characterized by the following constructive innovation, i.e. in that the pressure on the panel, preferably photovoltaic, is exerted through a rigid metal plane instead of through a silicone membrane as occurs in most laminators where the compression on the panel is generated through an imbalance between the pressure present in the chamber above the silicone membrane and the strong vacuum (about 1 mbar) present in the lower part thereof.

The second inventive step provides that the group comprises two or more stages. The first stage consists of the lamination chamber having a strong vacuum, the second, and possibly the third, is carried out in post-polymerization chambers, which are heated and insulated.

In a totally innovative way such chambers are at atmospheric pressure, not under pressure like the prior art, and in such a condition the plastic layers that are interposed in the panel (EVA, TPO, Silicone, PVB, Ionomer, POE or any other material) complete their adhesion process spontaneously.

By acting suitably on the parameters of time and temperature of the two or three chambers, surprisingly the plastic layers of the panel reach high levels of adhesion perfectly adequate for the technological requirements without acting in mechanical pressure.

Unlike the other multi-stage laminators, where all of the stages consist of a first chamber under vacuum and where a pressure is exerted, and of subsequent chambers in which a pressure continues to be exerted, the laminator of the present invention thus has only the lamination chamber under a vacuum and the subsequent post-polymerization chambers heated and at atmospheric pressure.

The laminator made according to the present invention is characterized by high quality characteristics, absent in membrane laminators.

In general, these quality characteristics are due to the perfectly even and axial pressure over the entire surface of the panel that membrane laminators cannot ensure.

These high quality characteristics include:
high planarity;
absence of optical deformation in reflection;
almost total absence of plastic burrs on the edge of the panels;
absence of sliding between the layers constituting the panel.

It must be emphasized that the value of these high quality characteristics is not only aesthetic.

The panels thus made are indeed longer-lasting because they are devoid of permanent stress on the edges and defects of the plastic interlayers due to burrs coming out from the edges due to the greater pressure localized on such edges by the membrane.

Therefore, such panels are less subject to the risk of subsequent delaminations and penetration of moisture. These characteristics are particularly important in the case of use in countries with extreme weather, like in the presence of strong temperature ranges, high humidity, etc.

In such an embodiment the photovoltaic panel enters into the lamination chamber that is closed and inside which the vacuum is made up to an absolute pressure of about 1 mbar.

The panel is progressively heated up to the temperatures specified by the suppliers of the plastic interlayer sheets. The upper part of the lamination chamber is limited by a rigid movable plane that during the de-aeration step does not press against the panel. Thereafter, the rigid plane is lowered to press on the panel with a pressure sufficient to seal the edges thereof and avoid, consequently, the re-entry of air. Once the predetermined time has passed, the rigid movable plane is raised and the lamination chamber opens to allow the transfer of the panel into the post-polymerization chamber.

In such a chamber the panel is kept at atmospheric pressure and at constant temperature through the heating sheet arranged under the support plane for the time necessary, in order to complete the polymerization of the plastic interlayer contained in the panel.

In a surprising manner and against the technical preconceptions, the atmospheric pressure ensures an even pressure on the panel itself, sufficient to ensure a complete adhesion of the plastic interlayers.

In the compression step of the de-aerated panel the pressure transmitted by the rigid plane on the photovoltaic panel is generated by the thrust of a certain number of pistons arranged on the upper part of the laminator that act on the rigid plane. The same pistons, as well as controlling the downward motion of the rigid plane, are responsible for lifting the plane once the pressing has ended.

Such an embodiment is very simple from the constructive point of view and has advantages in terms of volumes of air to be sucked during the de-aeration step.

According to the invention, the volume of the chamber is reduced because it is only defined by the stroke of the rigid plane.

In particular, since the space usually necessary for possible lifting feet of the panel are no longer required and at the same time having a vacuum tank of small size, for example of equal volume to the opening of the valves, it is possible to ensure a reduced volume of the chamber. In this case, the de-aeration pressure of 500 mbar is reached almost instantaneously. Such a pressure is also easily reduced with a system of vane pumps or screw pumps in series with a Roots pump. The de-aeration cycle is thus also optimized.

The present invention introduces, moreover, a further functional element for making the group able to be used for different types of panels as well as useful in the heating step of the panel.

Such an element comprises a sort of soft thermal cover, in the rest of the present description called “thermal cover”. The thermal cover is loosely associated with the inner surface of the rigid movable plane and faces the panel to be worked so as to be able to make contact with the panel before the rigid plane has reached the lowered compression position.

Such a soft thermal cover preferably comprises a support mat or belt made of Teflon or similar materials, i.e. plastics resistant to high temperatures and equipped with non-stick characteristics, and one or more sheets of silicone arranged between such a Teflon support belt and the rigid plane itself.

The use of the aforementioned thermal cover makes it possible to see the pointlessness of having special feet coming out from the support plane of the glass, thus contributing further to simplifying the group and substantially reducing the volume of the lamination chamber 11 in which it is necessary to make the vacuum. Of course, the term Teflon mat or belt is meant to indicate a mat or belt even only coated in Teflon, or equivalent material, made of Kevlar or fiberglass or other.

Such a coating has an innovative configuration so that:
when the rigid plane is in position of maximum lift it does not influence the de-aeration step;
even before the rigid plane reaches the lowered position the thermal cover is in at least partial contact with the entire surface of the panel so as to transfer heat to the latter without acting by compression;
when the rigid plane is in lowered position by acting on the panel only with its own weight so as to transfer heat faster since the rigid plane is electrically heated;
when the rigid plane is in lowered position and pressed against the panel, the thermal cover is in compressed configuration so that on one side the compression is transferred against the panel and on the other side possible local thickness variations of the panel are compensated preventing it from breaking.

In the case of photovoltaic panels the term breaking of the panel is also meant to indicate just the breaking of the photovoltaic cells embedded in the internal layers of the panel.

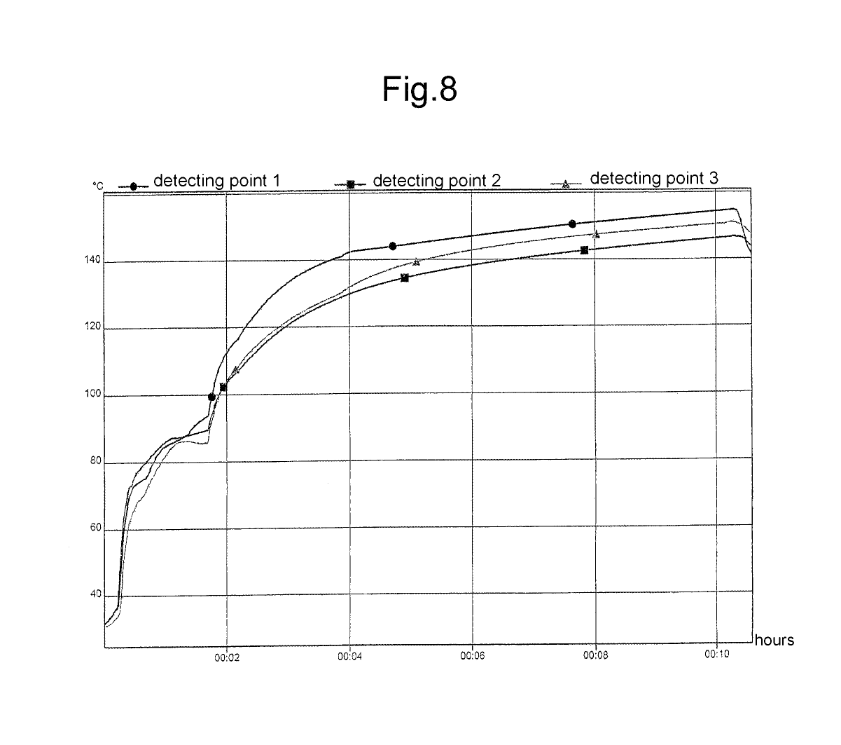

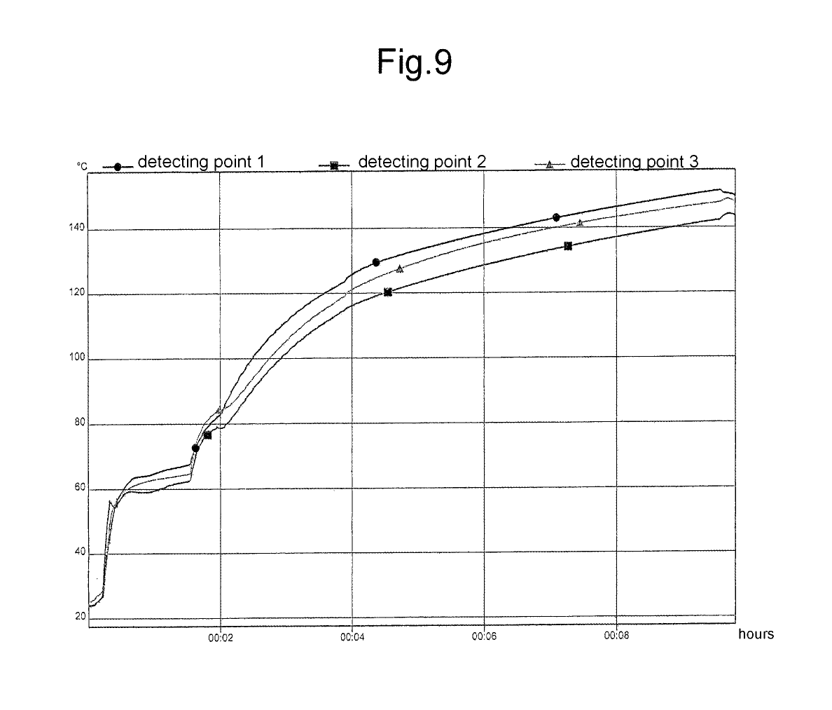

Since it is possible to foresee at least two inner silicone layers and heating means arranged between such two inner silicone layers, the panel is heated before the compression step and very quickly, FIGS. 8 and 9 proving as much, as soon as it is inserted in the chamber through the contact with a soft layer rested above it. Such “heated” contact allows two distinct benefits on the quality of the product and on the productivity of the group, i.e. greater homogeneity of heat distribution on the panel with elimination of the “butterfly” effect and, surprisingly, a reduction of the machining cycle and therefore much greater productivity of the group.

Further characteristics of the laminator group according to the invention will be highlighted by the description and by the following claims.

The characteristics and advantages of a laminator group according to the present invention will become clearer from the following description, given as an example and not for limiting purposes, referring to the attached schematic drawings, in which:

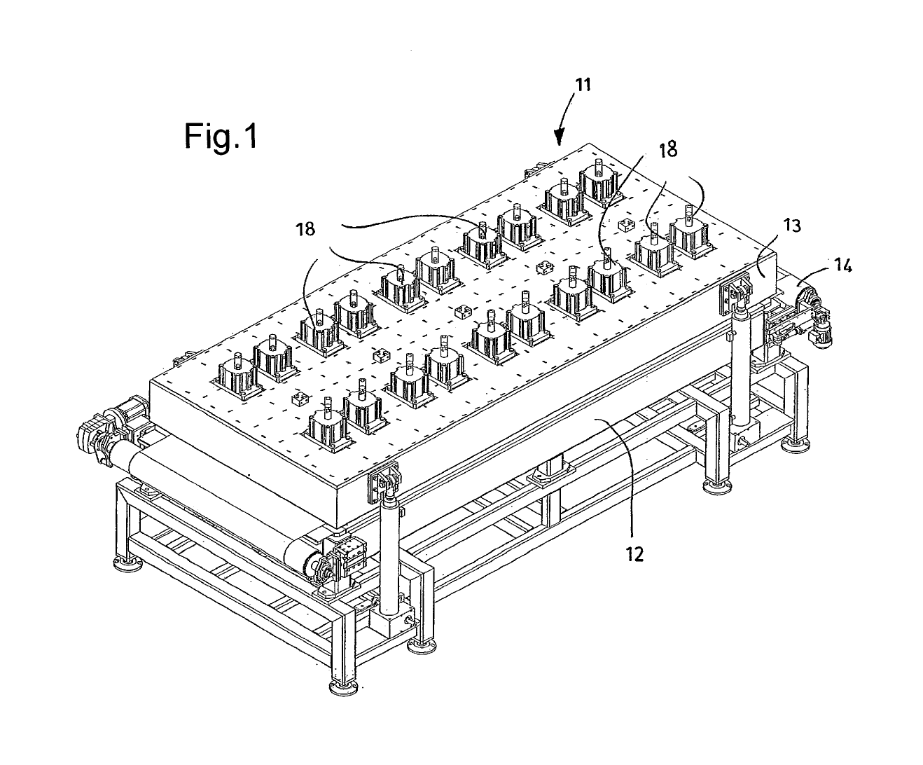

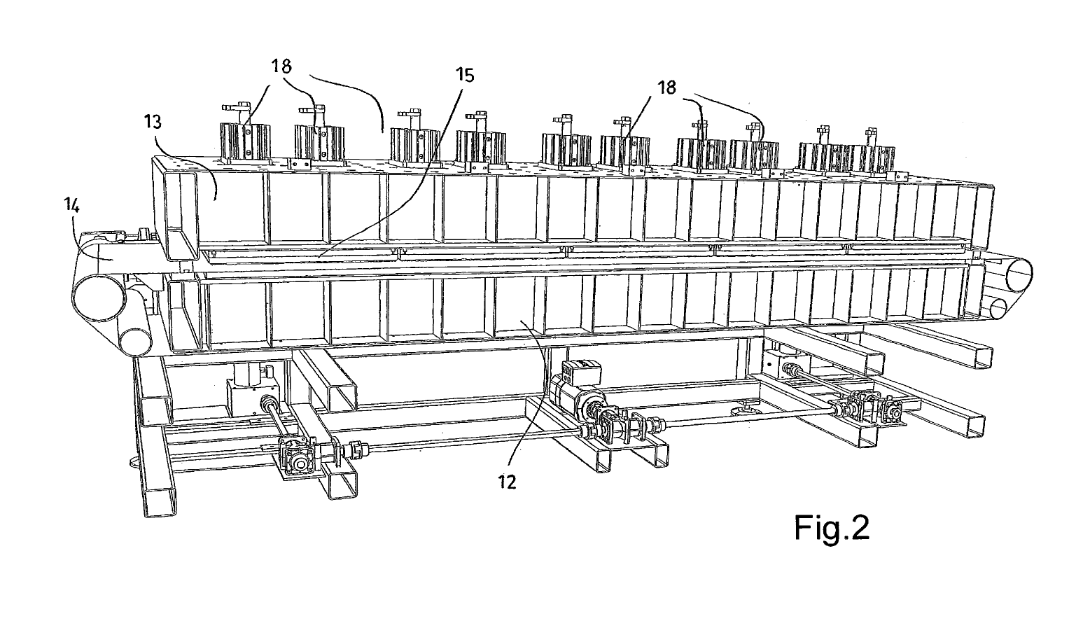

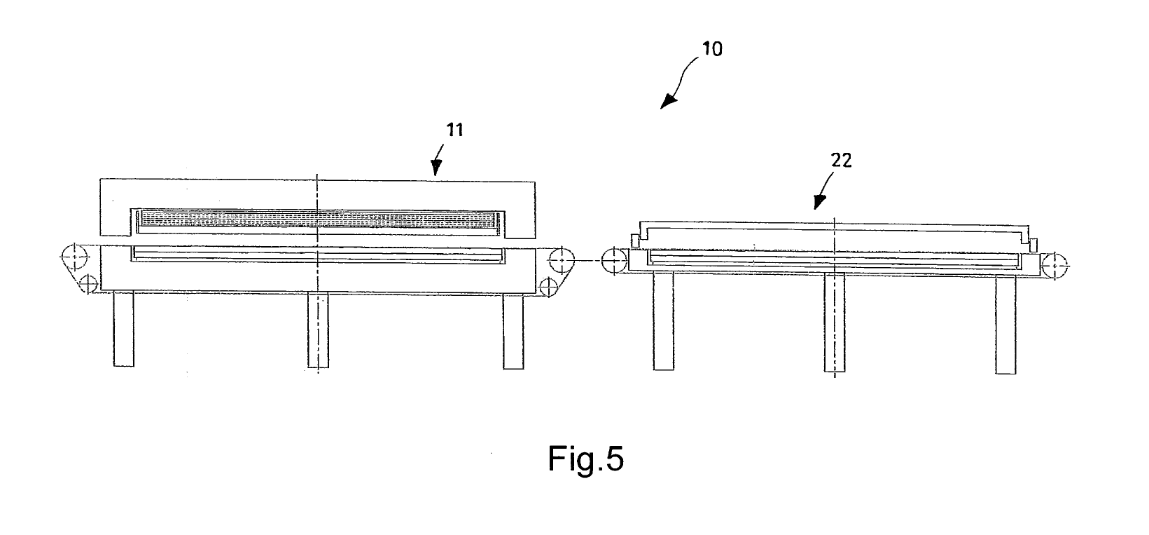

FIGS. 1-5 show an embodiment of the invention;

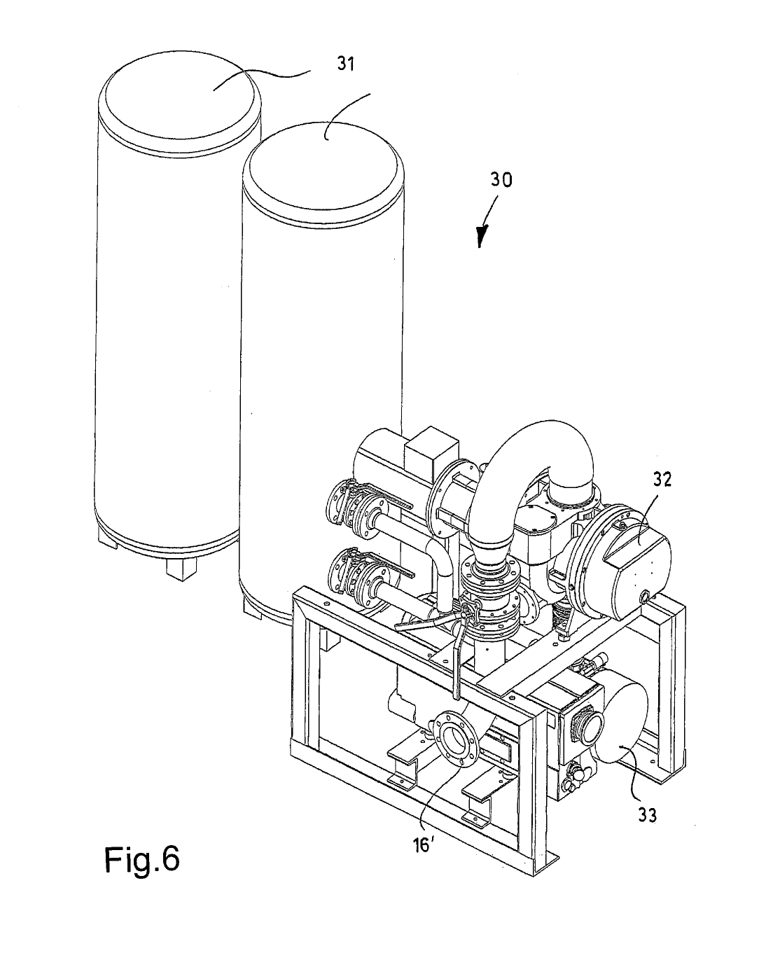

FIG. 6 shows the pumping system;

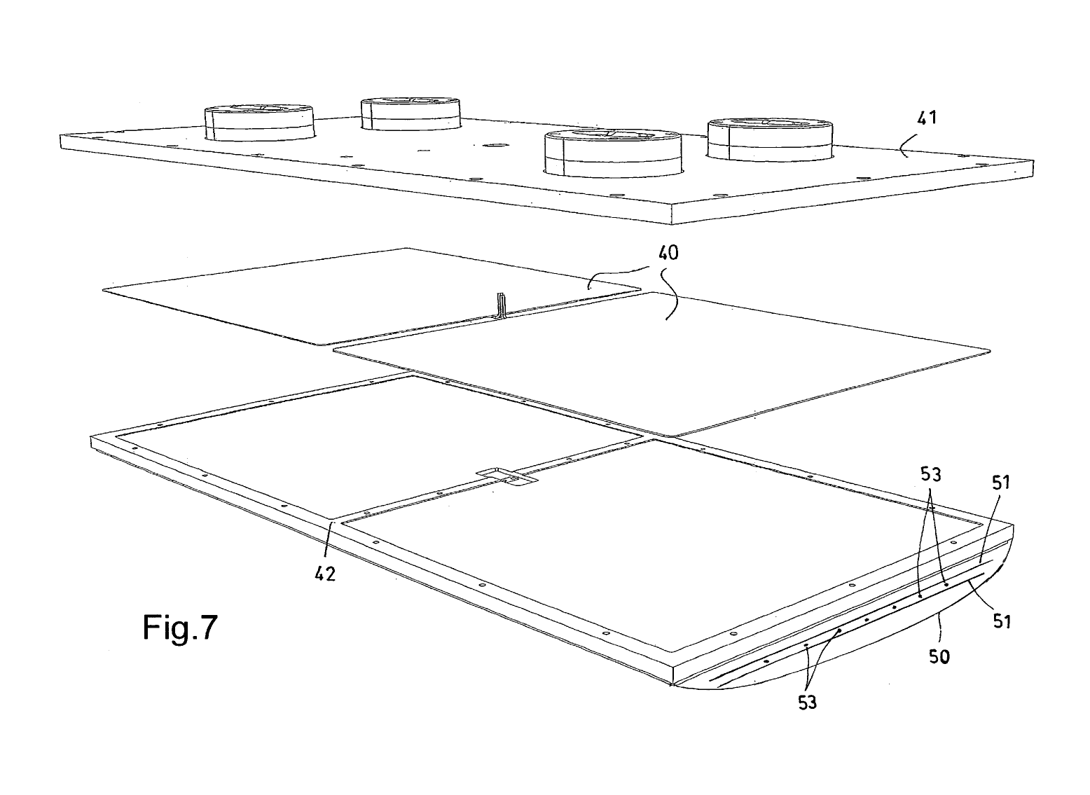

FIG. 7 shows the rigid plane exploded according to the present invention; and

FIGS. 8 and 9 show diagrams of the progression of the temperature measured in three points of the panel.

With reference to the figures, a laminator group according to the present invention is shown with 10.

Such a laminator group 10 is of the membrane-less type and comprises, in its most reduced form, at least one sealed lamination chamber 11 fed in succession with at least one multi-layer panel 17 and a pump unit 30 for the selective evacuation of the air present in the lamination chamber 11.

The term “at least one” lamination chamber 11 is meant to indicate that the present invention aims to comprise both multi-plane embodiments, and mono-plane ones fed simultaneously with a plurality of panels.

The lamination chamber 11 comprises a base 12, of the known type, which acts as support and abutment for the panels, and a movable cover 13 for opening and closing the lamination chamber 11.

The means for opening and closing the chamber are of the known type.

The means for the selective feeding 14 of the panels are also of the known type and are schematized in the form of belts.

According to the invention, inside the lamination chamber 11 there is, as compression member, a rigid movable plane 15 instead of the silicone membrane currently used in the vast majority of groups of this type.

Such a rigid movable plane 15, preferably made of aluminum, is movable between a raised position spaced from the panels and a lowered position in which it acts in compression against them.

Of course, means for controlling the motion of the rigid movable plane 15 and means for heating the lamination chamber 11 or the multi-layer panel 17 contained in it are provided.

Specifically, the first innovative characteristic of the invention was that of comprising the heating means, for example electrical resistances or equivalent 40, embedded inside said rigid movable plane 15.

In order to avoid the classic problems of the rigid plane, highlighted earlier with reference to the presence of pointed projections on the upper face of the panel, the surface of the rigid movable plane 15 facing the multi-layer panel 17 is loosely associated with a soft thermal cover 52, i.e. that is at least partially deformable, so that:
when the rigid movable plane 15 is in position of maximum lift it does not affect the de-aeration step;
even before the rigid movable plane 15 reaches the lowered position, the thermal cover 52 is in contact, at least partially, with the multi-layer panel 17 so as to transfer heat to the latter without acting by compression;
when the rigid plane is in lowered position acting on the panel only with its own weight so as to transfer heat faster since the rigid plane is electrically heated;—when the rigid movable plane 15 is in lowered position and pressed against the panel, the thermal cover 52 is in compressed configuration so that on one side it transmits the compression against the multi-layer panel 17 and on the other side it compensates possible local thickness variations of the multi-layer panel 17 preventing it from breaking.

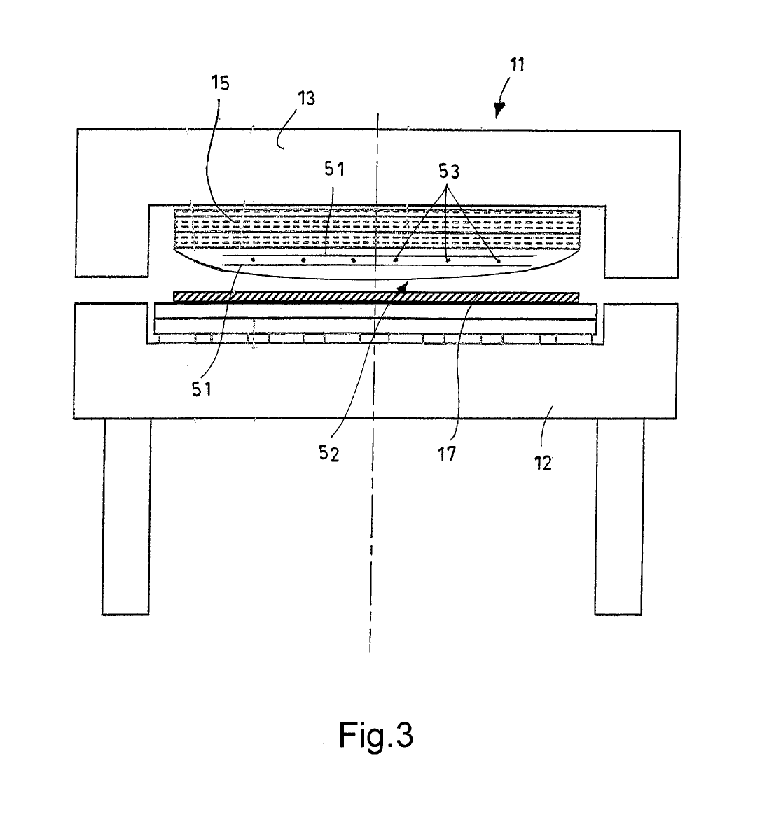

In FIGS. 3 and 7, such a thermal cover 52 is visible in schematized form.

Preferably, the thermal cover 52 is of the multi-layer type comprising an outer layer 50 made in the form of a mat or belt made of Teflon or plastic material resistant to high temperatures (up to 300° C.) with high non-stick properties and at least one inner silicone layer 51.

Again preferably, the outer layer 50 of the thermal cover 52 is constrained to the surface of the rigid movable plane 15 facing the panel only laterally or perimetrically so as to make a loose cavity when the rigid movable plane 15 is in raised position.

In such an embodiment, advantageously, between the silicone layers 51 it is possible to arrange heating means, such as electrical resistances 53 for example as alternatives or in addition to those embedded in the rigid movable plane 15.

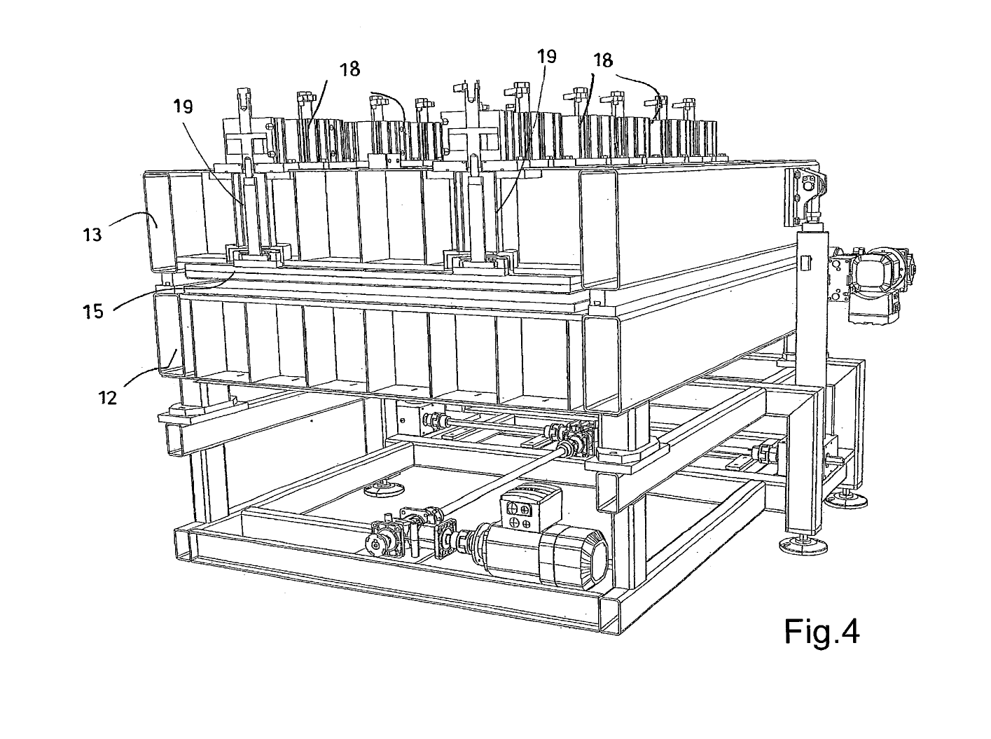

FIGS. 4 and 7 indeed show how the rigid movable plane 15 is formed from two metal sheets 41, 42 inside which the electrical resistances 40 are housed.

Advantageously, in order to provide greater specific power and compensate for the higher dissipations of heat on the edges of the multi-layer panel 17 in formation, the laminator group 10 is equipped with suitable heating electrical resistances (not represented in the attached figures) or similar localized heating devices divided into independently activatable areas inside the rigid movable plane 15.

In particular, the aforementioned heating electrical resistances or the alternative heating devices identify, in the lamination chamber 11, distinct heating areas, like for example the central area, the perimeter bands and the corner areas.

On the upper metal sheet 41 of the rigid movable plane 15 it is possible to see the connection seats with the relative mechanical movement means.

In this way, and thanks to the concurrent effect of the thermal cover the aforementioned “butterfly” curvature is avoided without having to use lifting feet of the panel that, once it has entered inside the mold, would come into contact with the heated lower plane. For the composition of the layers of the photovoltaic multi-layer panel 17 reference should be made to the initial part of the present application.

The means for controlling the motion of the rigid movable plane 15 are of the mechanical type.

Of course, such means for controlling the motion of the rigid movable plane 15 can be independent from the heating means of the chamber. Although in the example shown the heating means are presented associated or embedded in the rigid plane, it is absolutely possible to use other heating methods.

For example, in the post-polymerization chambers 22 infrared lamps can be used, acting both from below and from above in the chamber.

As shown in FIGS. 1-5, the movement means comprise a plurality of pistons 18 acting mechanically on the rigid movable plane 15 to control the motion thereof and to impose a controlled compression on the panel 17. In such an embodiment the pistons 18 are housed above the movable cover 13 and connected to the rigid movable plane 15 through suitable holes 19.

Such an arrangement is extremely advantageous because, together with the absence of the lifting feet, it makes it possible to reduce the volume of air inside the chamber and, therefore, makes the relative emptying easier.

Advantageously, the pistons 18 are equipped with a control system, preferably programmable electronic, capable of differentiating individually or in predetermined groups and, therefore areas, the pressure to be exerted on the multi-layer panel 17 in formation. Preferably, the control system is set so as to differentiate the pressure exerted on the multi-layer panel 17 in formation, between a central area and a perimeter area, in particular circumscribing the central area.

Advantageously, the Applicant has devised a suitable pump unit with vacuum tanks connected to the chamber 11 for a first, almost instantaneous, evacuation, joined to a vane or screw pump in series with a Roots pump.

In FIG. 6 reference numeral 30 indicates the group where it is possible to see the flange 16′ for connecting to a respective flange (not shown) of the chamber 11, the vacuum tanks 31, the vane or screw pump in series with a Roots pump 32, 33.

Moreover, instead of the outer vacuum tanks 31 volumes that are already present could be used for the same purpose for constructive reasons in the structure of the laminator thus further reducing the elements of the lamination group.

In particular, it is possible to exploit respective cavities defined in the structures of the base 12 and of the movable cover 13 of the laminator group 10 as vacuum tanks, with clear benefits in terms of compactness and total bulk of the group itself. An additional pump (not illustrated) for producing a vacuum, preferably operating continuously is connected to the cavities of the movable cover 13 through a flexible pipe to allow the vertical movement of the latter. The additional pump is also connected to the cavities of the base 12 through a rigid pipe. In this way, it is possible to ensure that the predetermined level of vacuum is reached in very quick time.

In accordance with such a solution, when the vacuum cycle starts, the cavities are placed in fluid communication with the main vacuum chamber, almost instantaneously reaching a depression equal to the ratio between the total volume of the aforementioned cavities and the volume of the lamination chamber.

The aforementioned ratio between the sum of the volumes of the cavities according to the movable cover 13 and to the base 12 and the volume of the lamination chamber is preferably about 5/1 for which reason in the main vacuum chamber a pressure of about 200 mbar is reached instantaneously.

Totally theoretically, the group could be made up of just the chamber 11 and the relative pumping and heating system.

Indeed, once the compression of the panel has been obtained, the subsequent post-polymerization steps could be carried out in the heated chamber 11 and open at atmospheric pressure.

However, as known, to increase production it is suitable to foresee at least one separate post-polymerization chamber 22 downstream of the lamination chamber 11.

In an innovative manner according to the invention, the post-polymerization chamber 22 is of the heated type and subjected to atmospheric pressure.

Unlike the prior art it foresees the operation of pressure also in such post-polymerization chambers.

It is extremely easy to understand the operation of the laminator group of the present invention described above in its structural components.

Indeed, the method for making laminated panels, in particular photovoltaic panels, through a group as described earlier comprises the steps of:

a) feeding at least one multi-layer panel 17 to a lamination chamber of the type having a rigid movable plane 15;
b) evacuating the air from the chamber to make the vacuum;
c) heating the multi-layer panel 17;
d) pressing the multi-layer panel 17 through the rigid movable plane 15.

Since, as described earlier, the surface of the rigid movable plane 15 facing the panel is loosely associated with the thermal cover 52, the step c) of heating the panel comprises the sub-step of bringing the thermal cover 52 into at least partial contact with the multi-layer panel 17 even before the rigid movable plane 15 reaches the lowered position so as to transfer heat to the multi-layer panel 17 without acting by compression. Again thanks to the presence of the thermal cover 52, the step d) of pressing said at least one multi-layer panel 17 takes place with the thermal cover 52 in compressed configuration so that, on one side it transfers the compression against the multi-layer panel and, on the other side, it compensates possible local thickness variations of the multi-layer panel 17 preventing it from breaking.

The subsequent post-polymerization step is carried out at atmospheric pressure feeding the multi-layer panel 17 directly from the lamination chamber 11 to a post-polymerization chamber 22 open at atmospheric pressure. The multi-layer panel 17 obtained with the laminator group 10 and the method described is recognizable because it is qualitatively better in terms of absence of the aforementioned defects.

It has thus been seen that a laminator group according to the present invention achieves the purposes highlighted earlier, also making it possible to make multi-layer panels of different shape and surfaces characteristics without requiring any specific setting as the type of multi-layer panel changes.

The laminator group of the present invention thus conceived can undergo numerous modifications and variants, all of which are covered by the same inventive concept; moreover, all of the details can be replaced by technically equivalent elements.

1. Membraneless laminator group (10) for making laminated panels, in particular photovoltaic panels, comprising at least one sealed lamination chamber (11) fed in succession by at least one multi-layer panel (17) and by a pump unit (30) for the selective evacuation of the air present in said lamination chamber (11); said lamination chamber (11) comprising a support and abutment base, (12), electrically heated, for said at least one multi-layer panel (17); a movable cover (13) for opening and closing said lamination chamber (11); means for the selective feeding (14) of said at least one multi-layer panel (17) into said lamination chamber (11); an electrically heated rigid plane (15) movable inside said chamber between a raised position spaced from said at least one multi-layer panel (17) and a lowered position wherein it acts in compression against said at least one multi-layer panel (17); means for controlling the motion of said movable rigid plane (15), characterized in that it comprises a thermal cover (52) loosely associated with the surface of said movable rigid plane (15) facing said at least one multi-layer panel (17), so that before said movable rigid plane (15) reaches said lowered position said thermal cover (52) contacts, at least partially, said at least one multi-layer panel (17) so as to transfer heat without acting by compression.

2. Group according to claim 1 characterized in that said thermal cover (52) is at least partially deformable so that, when said movable rigid plane (15) is in said lowered position, said thermal cover (52) can on one side transfer compression against said at least one multi-layer panel (17) and on the other side absorb and compensate for possible local thickness variations of said at least one multi-layer panel (17) and prevent, therefore, its breakage during the compression step.

3. Group according to claim 2 characterized in that said thermal cover (52) is of the multilayer type comprising an outer layer (50) made of plastic material which is high temperature resistant and has high non-stick properties and at least an inner silicon layer (51).

4. Group according to claim 3 characterized in that said outer layer (50) of said thermal cover (52) is made as a Teflon tape laterally constrained to said surface of said movable rigid plane (15) facing said at least one multi-layer panel (17) only laterally so as to obtain a loose cavity when said rigid plane (15) is in said raised position.

5. Group according to claim 1 characterized in that it comprises at least two inner silicon layers; heating means interposed between said inner silicon layers being provided.

6. Group according to claim 1 characterized in that said means for controlling the motion of said movable rigid plane (15) comprise a plurality of pistons (18) acting mechanically on said rigid plane (15) to control the motion thereof and to impart a controlled compression to said at least one multi-layer panel (17).

7. Group according to claim 6 characterized in that said pistons (18) are housed above said movable cover (13) and connected to said rigid plane (15) through suitable holes (19).

8. Group according to claim 1 characterized in that it comprises at least one post-polymerization chamber (22) downstream of said lamination chamber (11), said at least one post-polymerization chamber (22) being of the heated type and subjected to atmospheric pressure.

9. Group according to claim 1, wherein the base (12) and the movable cover (13) of the laminator group (10) each have respective cavities that act as vacuum tanks, at least one additional pump for producing a vacuum, preferably operating continuously, being connected to the cavities of the movable cover (13) through at least one flexible pipe to allow the movement of the latter, the additional pump also being connected to the cavities of the base (12) through at least one rigid pipe.

10. Group according to claim 9, wherein the sum of the volumes of the cavities of the movable cover (13) and of the base (12) and the volume of the lamination chamber (11) is preferably about 5/1.

11. Method for making laminated panels, in particular photovoltaic panels, through a group comprising the steps of:
a) feeding at least one multi-layer panel (17) to a lamination chamber of the type with a rigid movable plane (15);
b) evacuating the air from said chamber to make the vacuum;
c) heating said multi-layer panel (17);
d) pressing said at least one multi-layer panel (17) through said rigid movable plane (15);
wherein the surface of said rigid movable plane (15) facing said at least one multi-layer panel is loosely associated with a thermal cover (52) that is at least partially deformable so that:
said step c) of heating said multi-layer panel (17) comprises:
the step of bringing said thermal cover (52) in at least partial contact with said at least one multi-layer panel (17) even before said rigid movable plane (15) reaches said lowered position so as to transfer heat to the multi-layer panel (17) without acting by compression; and, thereafter,
the step of bringing the rigid movable plane (15) into contact with the multi-layer panel (17) so as to act on the latter only with the weight of the rigid movable plane (15) to allow the transfer of heat from the latter to the multi-layer panel (17);
step d) of pressing said at least one multi-layer panel (17) that takes place with said thermal cover (52) in a compressed configuration, so that on one side compression is transmitted against said at least one multi-layer panel (17) and on the other side possible local thickness variations of said at least one multi-layer panel (17) are compensated and it is thus prevented from breaking during the compression step.

12. Method according to claim 11 also comprising the step e) of arranging said multi-layer panel (17) directly from said lamination chamber (11) to a post-polymerization chamber (22) of the heated type and subjected to atmospheric pressure.
